(19) United States
(12) Patent Application Publication
(10) Pub. No.: US 2026/0063491 A1
(43) Pub. Date: Mar. 5, 2026

(54) PRESSURE SENSOR DEVICE

(71) Applicant: Murata Manufacturing Co., Ltd., Nagaokakyo-shi (JP)

(72) Inventors: Mami UCHIDA, Nagaokakyo-shi (JP); Koichi YOSHIDA, Nagaokakyo-shi (JP)

(21) Appl. No.: 19/377,136

(22) Filed: Nov. 3, 2025

Related U.S. Application Data
(63) Continuation of application No. PCT/JP2024/014388, filed on Apr. 9, 2024.

(30) Foreign Application Priority Data
Jun. 13, 2023 (JP) 2023-096863

(51) Int. Cl. G01L 9/00

(52) U.S. Cl. CPC G01L 9/0072

(57) ABSTRACT

A pressure sensor device that includes: a base having electroconductivity; an intermediate layer on the base and defining an opening; and an electrode on the intermediate layer and including a diaphragm portion that faces the opening. The opening includes a through-hole that extends through the intermediate layer in the lamination direction, and a pair of recesses on an upper surface of the intermediate layer such that the through-hole is therebetween. The intermediate layer includes a base-side electroconductive layer that is a bottom surface of the pair of recesses. The pressure sensor device further includes a pair of opposing portions that oppose each other and that protrude from at least one of the base-side electroconductive layer or the diaphragm portion and protrude toward the pair of recesses. The pair of opposing portions overlap edge portions of the pair of recesses closer to the through-hole.

### CROSS REFERENCE TO RELATED APPLICATIONS

The present application is a continuation of International application No. PCT/JP2024/014388, filed April 9, 2024, which claims priority to Japanese Patent Application No. 2023-096863, filed June 13, 2023, the entire contents of each of which are incorporated herein by reference.

### TECHNICAL FIELD

The present disclosure relates to a pressure sensor device that detects a pressure.

### BACKGROUND ART

A pressure sensor device capable of detecting capacitance changes over a wide range from low pressure to high pressure is known (for example, refer to Patent Documents 1 and 2).

The pressure sensor device disclosed in Patent Document 1 includes a first electrode and a second electrode insulated by a space from each other. The second electrode warps with an application of pressure. Based on a change of the distance between the first electrode and the second electrode that occurs during warpage, a change of capacitance between the first electrode and the second electrode is detected. Based on the detected capacitance change, the pressure applied to the second electrode is measured.

The pressure sensor device disclosed in Patent Document 1 includes a leg protruding from the second electrode into a space. The leg is annular in a plan view. When the pressure applied to the second electrode is low, the leg is spaced apart from the first electrode. At this time, an outer portion and an inner portion of the leg in the second electrode warp as a single film. When the pressure applied to the second electrode is high, the second electrode warps, and the leg comes into contact with the first electrode. When the second electrode warps while the leg is in contact with the first electrode, the outer portion and the inner portion of the leg in the second electrode warp as separate films. These separate films have higher stiffness than the single film. The use of these separate films thus enables detection of capacitance changes corresponding to high pressures.

A pressure sensor device disclosed in Patent Document 2 includes a fixed electrode and a diaphragm opposing across a gap. The diaphragm warps with an application of pressure. Based on a change of a gap between the fixed electrode and the diaphragm that occurs this time, a capacitance change between the fixed electrode and the diaphragm is detected. Based on the detected capacitance change, the pressure applied to the diaphragm is measured.

In the pressure sensor device disclosed in Patent Document 2, a protrusion is disposed at the center portion of the fixed electrode covered with an insulator film. The gap between the center portion of the fixed electrode and the diaphragm is smaller than the gap between the peripheral portion of the fixed electrode and the diaphragm. Thus, when high pressure is applied to the diaphragm, the center portion of the fixed electrode and the diaphragm come into contact with the insulator film interposed therebetween. At this time, based on the change of the gap at the peripheral portion of the fixed electrode, the change of capacitance between the fixed electrode and the diaphragm is detected.

Patent Document 1: Japanese Unexamined Patent Application Publication (Translation of PCT Application) No. 2018-521317

Patent Document 2: Japanese Unexamined Patent Application Publication No. 2005-321257

### SUMMARY OF THE DISCLOSURE

In the pressure sensor device disclosed in Patent Document 1, when a gap between the first electrode and the second electrode is widened, the sensitivity of detecting a capacitance change corresponding to low pressure applied to the second electrode is lowered. In contrast, when the gap between the first electrode and the second electrode is narrowed, the likelihood of the second electrode coming into contact with the first electrode when high pressure is applied to the second electrode increases. When the second electrode comes into contact with the first electrode, capacitance changes cannot be detected.

In the pressure sensor device disclosed in Patent Document 2, when high pressure is applied to the diaphragm, the center portion of the fixed electrode is in contact with the diaphragm with the insulator film interposed therebetween, and the gap at the center portion of the fixed electrode is thus not changed. Thus, changes of capacitance between the fixed electrode and the diaphragm are detected simply based on changes of the gap at the peripheral portion of the fixed electrode. This structure thus has lower sensitivity of detecting capacitance changes than a structure that detects changes of capacitance between the fixed electrode and the diaphragm based on changes of the gaps at both the center portion and the peripheral portion of the fixed electrode.

The present disclosure aims to provide a pressure sensor device capable of maintaining the sensitivity of detecting capacitance changes caused by an application of pressure over a wide range from low pressure to high pressure.

A pressure sensor device according to an aspect of the present disclosure includes: a base having electroconductivity; an intermediate layer on the base and defining an opening; an electrode having electroconductivity on a first surface of the intermediate layer opposite to a second surface thereof facing the base, the electroconductive electrode including a diaphragm portion that overlaps the opening when viewed in a lamination direction, the electroconductive electrode being electrically insulated from the base, wherein the opening includes: a through-hole that extends through the intermediate layer in the lamination direction, and a pair of recesses on the first surface of the intermediate layer, the pair of recesses being positioned such that the through-hole is therebetween, and the pair of recesses are continuous with the through-hole, and recessed in the lamination direction, wherein the intermediate layer includes a base-side electroconductive layer is a bottom surface of the pair of recesses and is electrically connected to the base, wherein the diaphragm portion faces the base-side electroconductive layer in the lamination direction across the pair of recesses, and faces the base in the lamination direction across the through-hole; and protrusions on a surface of at least one of the base-side electroconductive layer or the diaphragm portion facing the pair of recesses and protruding toward the pair of recesses, wherein the protrusions include a pair of opposing portions that oppose each other while spaced in a width direction between the pair of recesses, and wherein the pair of opposing portions overlap edge portions of the pair of recesses closer to the through-hole when viewed in the lamination direction.

The present disclosure can provide a pressure sensor device capable of maintaining detection sensitivity over a wide range of pressure from low pressure to high pressure.

### BRIEF DESCRIPTION OF THE DRAWINGS

FIG. 1 is a schematic end view of a pressure sensor device according to a first embodiment of the present disclosure.

FIG. 2 is a schematic plan view of the pressure sensor device according to the first embodiment of the present disclosure, at a portion excluding an electrode.

FIG. 3 is a schematic end view of the pressure sensor device according to the first embodiment of the present disclosure when low pressure is applied to an electrode.

FIG. 4 is a schematic end view of the pressure sensor device according to the first embodiment of the present disclosure when high pressure is applied to an electrode.

FIG. 5 is a schematic end view of a pressure sensor device according to a modification example of the first embodiment of the present disclosure, at a portion corresponding to FIG. 1.

FIG. 6 is a schematic end view of a pressure sensor device according to a modification example of the first embodiment of the present disclosure, at a portion corresponding to FIG. 1.

FIG. 7 is a schematic end view of a pressure sensor device according to a modification example of the first embodiment of the present disclosure, at a portion corresponding to FIG. 1.

FIG. 8 is a schematic plan view of a pressure sensor device according to a second embodiment of the present disclosure, at a portion excluding an electrode.

FIG. 9 is a schematic end view of a pressure sensor device according to a third embodiment of the present disclosure, at a portion corresponding to FIG. 1.

FIG. 10 is a schematic end view of a pressure sensor device according to a modification example of the third embodiment of the present disclosure, at a portion corresponding to FIG. 1.

FIG. 11 is a schematic end view of a pressure sensor device according to a modification example of the third embodiment of the present disclosure, at a portion corresponding to FIG. 1.

FIG. 12 is a schematic end view of a pressure sensor device according to a modification example of the third embodiment of the present disclosure, at a portion corresponding to FIG. 1.

### DESCRIPTION OF THE PREFERRED EMBODIMENTS

Examples of the present disclosure are described in accordance with attached drawings. The description given below is essentially mere examples, and is not intended to limit the present disclosure, its application, and its use. The drawings are schematic, and, for example, the dimensional ratios of components may be different from the actual ones. In the description given below, terms indicating specific directions or locations (such as terms including "above", "below", "right", "left", "front", or "rear") may be used as needed. However, the use of terms indicating specific directions or locations are used to facilitate understanding of the present disclosure with reference to the drawings, and the meanings of these terms are not intended to limit the technical scope of the present disclosure.

### First Embodiment

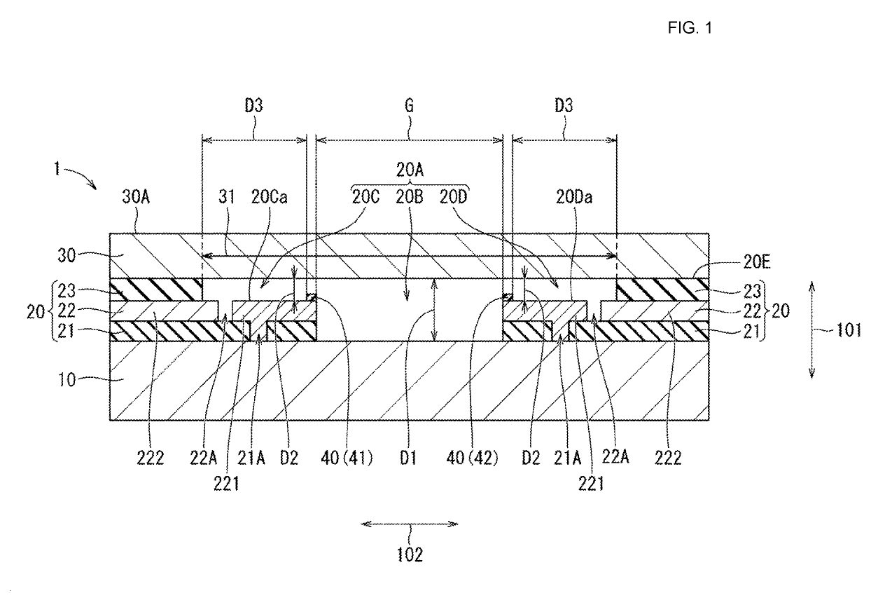

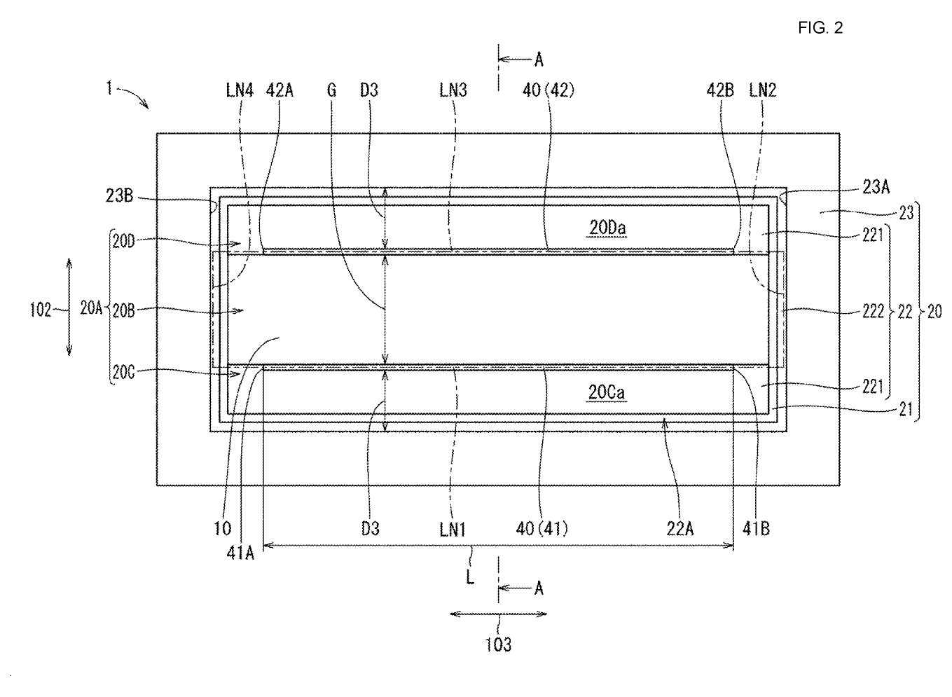

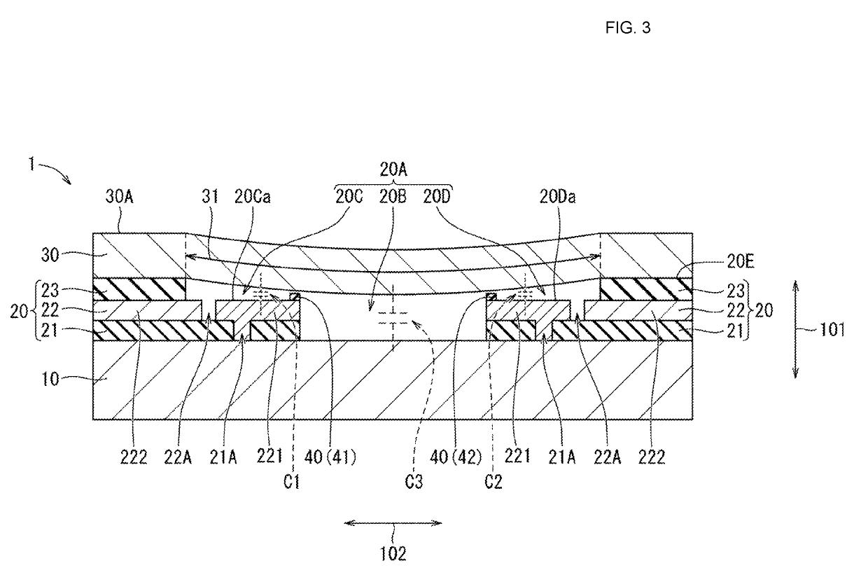

FIG. 1 is a schematic end view of a pressure sensor device according to a first embodiment of the present disclosure. FIG. 2 is a schematic plan view of the pressure sensor device according to the first embodiment of the present disclosure, at a portion excluding an electrode. FIG. 1, FIGS. 3 to 7, and FIGS. 9 to 12 described below are schematic end views corresponding to the cross section taken along A-A in FIG. 2.

A pressure sensor device 1 illustrated in FIG. 1 and FIG. 2 detects pressure. The pressure sensor device 1 is a capacitive device. In the first embodiment, the pressure sensor device 1 is a micro-electromechanical system (MEMS) device. The pressure sensor device 1 is mounted on, for example, a movable body such as an automobile, or a consumer device such as a smartphone or smartwatch.

The pressure sensor device 1 has a rectangular prism shape. However, the shape of the pressure sensor device 1 is not limited to the rectangular prism shape (a rectangular shape when viewed in a lamination direction 101). For example, the pressure sensor device 1 may have a shape of a polygon other than a quadrilateral shape, or a cylinder shape when viewed in the lamination direction 101.

As illustrated in FIG. 1 and FIG. 2, the pressure sensor device 1 includes a base 10, an intermediate layer 20, an electrode 30, and protrusions 40. The intermediate layer 20 is laminated on the base 10. The electrode 30 is laminated on a surface of the intermediate layer 20 opposite to a surface facing the base 10. The protrusions 40 are disposed on the intermediate layer 20.

In the first embodiment, the base 10 is rectangular when viewed in plan in the lamination direction 101 in which the base 10, the intermediate layer 20, and the electrode 30 are laminated. The base 10 has electroconductivity. In the first embodiment, the base 10 is formed from silicon (Si). The material of the base 10 is not limited to silicon. As described above, the shape of the pressure sensor device 1 is not limited to the rectangular prism shape. For example, when the pressure sensor device 1 has a cylindrical shape, the base 10 is circular when viewed in plan. More specifically, the base 10 is not limited to being rectangular when viewed in plan.

In the first embodiment, the intermediate layer 20 is rectangular when viewed in plan. As in the base 10, the intermediate layer 20 is not limited to being rectangular when viewed in plan. The intermediate layer 20 includes a first base-side insulating layer 21 having insulating properties, a base-side electroconductive layer 22 having electroconductivity, and a second base-side insulating layer 23 having insulating properties. The first base-side insulating layer 21 is laminated on the base 10. The base-side electroconductive layer 22 is laminated on a surface of the first base-side insulating layer 21 opposite to a surface facing the base 10. The second base-side insulating layer 23 is laminated on a surface of the base-side electroconductive layer 22 opposite to a surface facing the first base-side insulating layer 21.

In the first embodiment, the first base-side insulating layer 21 and the second base-side insulating layer 23 are formed from silicon dioxide (SiO₂), and the base-side electroconductive layer 22 is formed from polysilicon (poly-Si). The material of the first base-side insulating layer 21 and the second base-side insulating layer 23 is not limited to silicon dioxide. The material of the first base-side insulating layer 21 and the material of the second base-side insulating layer 23 may differ from each other. The material of the base-side electroconductive layer 22 is not limited to polysilicon.

The base-side electroconductive layer 22 includes fixed electrodes 221 and a surrounding electroconductive layer 222 that surrounds the fixed electrodes 221 when viewed in plan.

Between the fixed electrodes 221 and the surrounding electroconductive layer 222, a gap 22A is formed. Thus, the fixed electrodes 221 and the surrounding electroconductive layer 222 are electrically insulated.

As illustrated in FIG. 1, the fixed electrodes 221 are electrically connected to the base 10 with through-holes 21A that extend through the first base-side insulating layer 21 in the lamination direction 101.

As illustrated in FIG. 1 and FIG. 2, the intermediate layer 20 has an opening 20A. In the first embodiment, the opening 20A includes a through-hole 20B and a pair of recesses 20C and 20D. The through-hole 20B extends through the intermediate layer 20 in the lamination direction 101. The pair of recesses 20C and 20D are formed on an upper surface 20E of the intermediate layer 20, and recessed from the upper surface 20E of the intermediate layer 20 in the lamination direction 101. The upper surface 20E of the intermediate layer 20 is one of surfaces of the intermediate layer 20 facing the electrode 30.

The through-hole 20B extends in a longitudinal direction 103. The longitudinal direction 103 is parallel to the long sides of the rectangular pressure sensor device 1 when viewed in plan. The longitudinal direction 103 is orthogonal to the lamination direction 101. The through-hole 20B is continuous with the gap 22A at both end portions in the longitudinal direction 103. The bottom surface of the through-hole 20B is formed from the upper surface of the base 10. Side surfaces of the through-hole 20B are formed from side surfaces of the first base-side insulating layer 21 and the base-side electroconductive layer 22. The through-hole 20B has a depth D1 that is the same as a thickness of the intermediate layer 20 (the total thickness of the first base-side insulating layer 21, the base-side electroconductive layer 22, and the second base-side insulating layer 23).

The pair of recesses 20C and 20D extend through the second base-side insulating layer 23. In contrast, the pair of recesses 20C and 20D are not formed in the base-side electroconductive layer 22 and the first base-side insulating layer 21. The pair of recesses 20C and 20D are continuous with the gap 22A. The upper surface of the base-side electroconductive layer 22 (the surface of the base-side electroconductive layer 22 facing the pair of recesses 20C and 20D) serves as a bottom surface 20Ca of the recess 20C and a bottom surface 20Da of the recess 20D. More specifically, the fixed electrodes 221 and parts of the surrounding electroconductive layer 222 serve as the bottom surfaces 20Ca and 20Da. The side surfaces of the second base-side insulating layer 23 serve as side surfaces of the pair of recesses 20C and 20D. The pair of recesses 20C and 20D have a depth D2 that is the same as the thickness of the second base-side insulating layer 23. The depth D2 of the pair of recesses 20C and 20D is smaller than the depth D1 of the through-hole 20B.

The pair of recesses 20C and 20D face each other across a gap in a lateral direction 102. The lateral direction 102 is parallel to the short sides of the rectangular pressure sensor device 1 in a plan view. The lateral direction 102 is orthogonal to the lamination direction 101 and the longitudinal direction 103. The lateral direction 102 is an example of the width direction. The lateral direction 102 and the longitudinal direction 103 do not necessarily have to be orthogonal to each other as long as they cross each other.

Between the pair of recesses 20C and 20D, the through-hole 20B is formed. More specifically, the pair of recesses 20C and 20D hold the through-hole 20B therebetween in the lateral direction 102. Each of the pair of recesses 20C and 20D and the through-hole 20B are continuous with each other. More specifically, the pair of recesses 20C and 20D are continuous with the through-hole 20B.

As illustrated in FIG. 1, the electrode 30 is laminated on the second base-side insulating layer 23 of the intermediate layer 20. In the first embodiment, when viewed in plan, the electrode 30 is rectangular. As in the base 10 described above, the electrode 30 is not limited to being rectangular when viewed in plan. The electrode 30 has electroconductivity. The electrode 30 is electrically insulated from the base 10.

In the first embodiment, the electrode 30 is formed from silicon (Si). The material of the electrode 30 is not limited to silicon.

The electrode 30 includes a diaphragm portion 31. The diaphragm portion 31 is a portion of the electrode 30 facing the opening 20A in the intermediate layer 20. In other words, the diaphragm portion 31 is a portion of the electrode 30 that overlaps the opening 20A when viewed in the lamination direction 101. The diaphragm portion 31 can warp. For example, the diaphragm portion 31 warps downward, more specifically, toward the opening 20A, when the pressure is applied to a first main surface 30A of the electrode 30.

The diaphragm portion 31 faces the base-side electroconductive layer 22 in the lamination direction 101 across the pair of recesses 20C and 20D, and faces the base 10 in the lamination direction 101 across the through-hole 20B.

As illustrated in FIG. 1 and FIG. 2, the protrusions 40 are disposed on the upper surfaces of the fixed electrodes 221 of the base-side electroconductive layer 22, more specifically, the bottom surfaces 20Ca and 20Da of the pair of recesses 20C and 20D. The protrusions 40 protrude upward from the bottom surfaces 20Ca and 20Da. In other words, the protrusions 40 protrude from the bottom surfaces 20Ca and 20Da toward the pair of recesses 20C and 20D.

In the first embodiment, the protrusions 40 have insulating properties. In the first embodiment, the protrusions 40 are formed from silicon dioxide (SiO₂) or silicon nitride (SiN). The material of the protrusions 40 is not limited to silicon dioxide (SiO₂) or silicon nitride (SiN).

The protrusions 40 include a pair of opposing portions 41 and 42. In the first embodiment, the protrusions 40 are formed from the pair of opposing portions 41 and 42. The opposing portion 41 is disposed on the bottom surface 20Ca. The opposing portion 42 is disposed on the bottom surface 20Da.

The pair of opposing portions 41 and 42 are disposed on the bottom surfaces 20Ca and 20Da at edge portions closer to the through-hole 20B in the lateral direction 102. In other words, the pair of opposing portions 41 and 42 are located to overlap edge portions of the pair of recesses 20C and 20D closer to the through-hole 20B when viewed in plan.

Each of the pair of opposing portions 41 and 42 extends rectilinearly in the longitudinal direction 103. The pair of opposing portions 41 and 42 are parallel to each other. The longitudinal direction 103 is an example of an extension direction.

The pair of opposing portions 41 and 42 face each other while being spaced apart from each other in the direction in which the pair of recesses 20C and 20D hold the through-hole 20B. In the first embodiment, the direction in which the pair of recesses 20C and 20D hold the through-hole 20B is the lateral direction 102.

As illustrated in FIG. 2, when viewed in plan, the area in the diaphragm portion 31 located between the pair of opposing portions 41 and 42 in the lateral direction 102 is rectangular. In other words, when viewed in plan, an area surrounded by four virtual straight lines LN1, LN2, LN3, and LN4 indicated by dot-and-dash lines in FIG. 2 is rectangular.

The virtual straight line LN1 extends over the opposing portion 41 in the longitudinal direction 103. The virtual straight line LN3 extends over the opposing portion 42 in the longitudinal direction 103. The virtual straight lines LN1 and LN3 extend to portions outside the pair of opposing portions 41 and 42 in the longitudinal direction 103. The virtual straight line LN2 extends in the lateral direction 102 over a side surface 23A, among side surfaces (surfaces extending in the lamination direction 101) of the second base-side insulating layer 23, facing one direction in the longitudinal direction 103. The virtual straight line LN4 extends in the lateral direction 102 over a side surface 23B, among the side surfaces of the second base-side insulating layer 23, facing another direction in the longitudinal direction 103. The virtual straight lines LN2 and LN4 cross the virtual straight lines LN1 and LN3.

In the first embodiment, a length L of the pair of opposing portions 41 and 42 in the longitudinal direction 103 is longer than a gap G between the pair of opposing portions 41 and 42 in the lateral direction 102.

In the first embodiment, the gap G between the pair of opposing portions 41 and 42 in the lateral direction 102 is longer than a shortest distance D3 between each of the pair of opposing portions 41 and 42 and an outer edge of the opening 20A in the lateral direction 102.

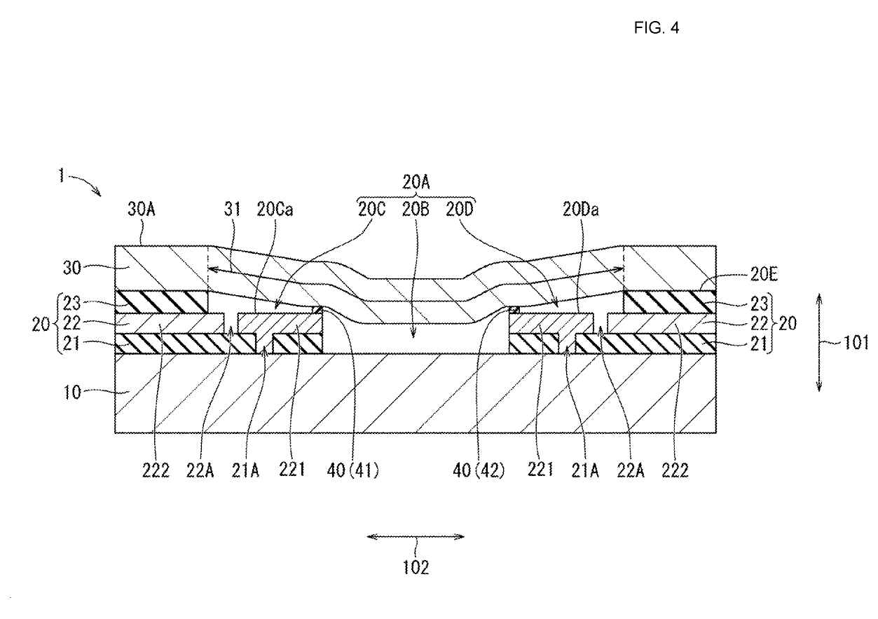

FIG. 3 is a schematic end view of the pressure sensor device according to the first embodiment of the present disclosure when low pressure is applied to an electrode. FIG. 4 is a schematic end view of the pressure sensor device according to the first embodiment of the present disclosure when high pressure is applied to an electrode.

With reference to FIG. 3 and FIG. 4, an operation of the diaphragm portion 31 of the electrode 30 when pressure is applied to the first main surface 30A of the electrode 30, and detection of capacitance in accordance with the operation are described below.

As described above, the diaphragm portion 31 faces the base-side electroconductive layer 22 in the lamination direction 101 across the pair of recesses 20C and 20D, and faces the base 10 in the lamination direction 101 across the through-hole 20B. Thus, as indicated by broken lines in FIG. 3, a capacitor C1 is formed by the diaphragm portion 31 and the fixed electrode 221 that oppose each other across the recess 20C. In addition, a capacitor C2 is formed by the diaphragm portion 31 and the fixed electrode 221 that oppose each other across the recess 20D. In addition, a capacitor C3 is formed by the diaphragm portion 31 and the base 10 that oppose each other across the through-hole 20B. Thus, a circuit in which these three capacitors C1, C2, and C3 are equivalently connected in parallel can be achieved.

The base 10 and the electrode 30 including the diaphragm portion 31 are each electrically connectable to external devices or elements with terminals not illustrated. Thus, based on the total capacitance of the three capacitors C1, C2, and C3, pressure can be measured by, for example, an external device or element when pressure is applied to the first main surface 30A of the electrode 30.

When pressure is applied to the first main surface 30A of the electrode 30, as illustrated in FIG. 3, the diaphragm portion 31 of the electrode 30 warps downward toward the base 10. When pressure applied to the first main surface 30A is low, the diaphragm portion 31 warps a small amount. The diaphragm portion 31 at this time is spaced apart from the pair of opposing portions 41 and 42 in the protrusions 40. Thus, the diaphragm portion 31 warps as a single film.

When the diaphragm portion 31 warps, the distance between the diaphragm portion 31 and the base-side electroconductive layer 22 in the lamination direction 101 and the distance between the diaphragm portion 31 and the base 10 in the lamination direction 101 decrease. With changes of these distances, capacitance of each of the capacitors C1, C2, and C3 increases. Based on the change of capacitance of each of the capacitors C1, C2, and C3, electric current flowing to, for example, an external device or element or a voltage applied to, for example, an external device or element changes. Based on this change of the electric current or voltage, pressure applied to the first main surface 30A of the electrode 30 is measured.

When pressure higher than the above is applied to the first main surface 30A, the diaphragm portion 31 warps a larger amount. The diaphragm portion 31 at this time comes into contact with the pair of opposing portions 41 and 42. When the diaphragm portion 31 warps further downward toward the base 10 while being in contact with the pair of opposing portions 41 and 42, as illustrated in FIG. 4, a portion of the diaphragm portion 31 corresponding to the capacitor C1, a portion of the diaphragm portion 31 corresponding to the capacitor C2, and a portion of the diaphragm portion 31 corresponding to the capacitor C3 warp as separate three films. The stiffness of these portions of the diaphragm portion 31 corresponding to these three films is greater than the stiffness of the diaphragm portion 31 (refer to FIG. 3) corresponding to a single film. Thus, the diaphragm portion 31 in the state illustrated in FIG. 4 is less likely to warp than in the state illustrated in FIG. 3. The upper limit of pressure measurable by the pressure sensor device 1 can thus be raised.

In the first embodiment, when the diaphragm portion 31 warps a small amount, more specifically, when low pressure is applied to the diaphragm portion 31, the diaphragm portion 31 does not come into contact with the pair of opposing portions 41 and 42. At this time, based on a change of capacitance between the diaphragm portion 31 and the base-side electroconductive layer 22 and a change of capacitance between the diaphragm portion 31 and the base 10, low pressure applied to the diaphragm portion 31 can be measured highly sensitively. When the diaphragm portion 31 warps a larger amount, more specifically, when high pressure is applied to the diaphragm portion 31, the diaphragm portion 31 comes into contact with the pair of opposing portions 41 and 42. The diaphragm portion 31 at this time functions as different films at a portion between the pair of opposing portions 41 and 42 and at both portions outside the pair of opposing portions 41 and 42. In this case, the stiffness of these different films increases. High pressure applied to the diaphragm portion 31 can thus be measured highly sensitively.

In the first embodiment, when viewed in the lamination direction 101, the through-hole 20B is located between the pair of opposing portions 41 and 42, and the pair of recesses 20C and 20D are located at both portions outside the pair of opposing portions 41 and 42. The depth D1 of the through-hole 20B is thus greater than the depth D2 of the pair of recesses 20C and 20D. Thus, when high pressure is applied to the diaphragm portion 31, the diaphragm portion 31 that warps between the pair of opposing portions 41 and 42 is less likely to come into contact with the base 10.

When pressure is applied to a diaphragm portion that is square when viewed in the lamination direction 101, the amount of displacement of the diaphragm portion is largest at the center of the diaphragm portion, and the amount of displacement decreases with distance from the center. In contrast, in the first embodiment, a portion of the diaphragm portion 31 surrounded by the four virtual straight lines LN1, LN2, LN3, and LN4 when viewed in the lamination direction 101 is rectangular. As in the first embodiment, in the diaphragm portion 31 that is rectangular when viewed in the lamination direction 101, when pressure is applied to the diaphragm portion 31, the amount of displacement of the diaphragm portion 31 is largest at the center in the direction along the short sides of the rectangle, and the amount of displacement decreases with distance from the center. The portion with the largest amount of displacement extends along the long sides of the rectangle. More specifically, in the diaphragm portion 31 that is rectangular when viewed in the lamination direction 101, the portion with the largest amount of displacement is a line, not a point. More specifically, the diaphragm portion 31 that is rectangular when viewed in the lamination direction 101 can have a larger area in which the diaphragm portion has uniform displacement than a diaphragm portion that is square when viewed in the lamination direction 101. Thus, a capacitance change caused by warpage of the portion of the diaphragm portion 31 surrounded by the four virtual straight lines LN1, LN2, LN3, and LN4 can be detected highly accurately.

For example, when the diaphragm portion is circular, the size of the diaphragm portion can be adjusted by simply changing the diameter of the circle. In the first embodiment, the portion of the diaphragm portion 31 surrounded by the four virtual straight lines LN1, LN2, LN3, and LN4 is rectangular. In this case, the size of the diaphragm portion 31 can be adjusted by two methods, that is, by changing the dimension of the long sides of the rectangle, and by changing the dimension of the short sides of the rectangle. Thus, in the first embodiment, the size and the shape of the diaphragm portion can be more freely changed to correspond to the shape of the pressure sensor device than when the diaphragm portion is circular.

In the first embodiment, the rectangle surrounded by the four virtual straight lines LN1, LN2, LN3, and LN4 may be a rectangle with the long sides extending in the extension direction (longitudinal direction 103) of the pair of opposing portions 41 and 42. Thus, the pair of opposing portions 41 and 42 may be elongated in the extension direction, and the area over which the diaphragm portion 31 comes into contact with the pair of opposing portions 41 and 42 may be increased. This structure can thus enhance the stability of the diaphragm portion 31 when the diaphragm portion 31 comes into contact with the pair of opposing portions 41 and 42.

In the first embodiment, the gap G between the pair of opposing portions 41 and 42 in the lateral direction 102 is longer than the shortest distance D3 between each of the pair of opposing portions 41 and 42 and the outer edge of the opening 20A in the lateral direction 102. In this case, regardless of whether the opening 20A is square or rectangular, the area between the pair of opposing portions 41 and 42 can be rectangular.

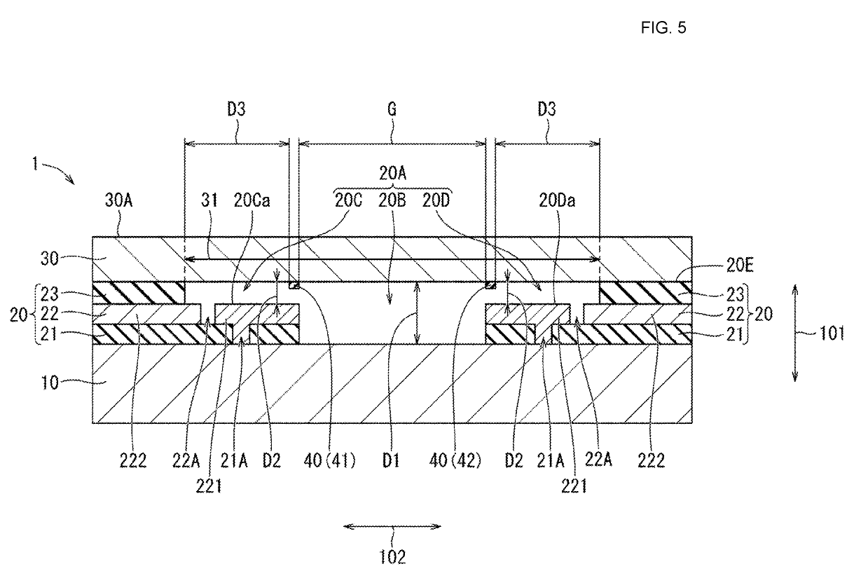

FIG. 5 is a schematic end view of the pressure sensor device according to a modification of the first embodiment of the present disclosure, at a portion corresponding to FIG. 1. As illustrated in FIG. 5, the protrusions 40 may be disposed on the diaphragm portion 31.

The protrusions 40 are disposed on the surface of the diaphragm portion 31 facing the pair of recesses 20C and 20D (in other words, the lower surface of the diaphragm portion 31). The protrusions 40 protrude downward from the diaphragm portion 31. In other words, the protrusions 40 protrude from the diaphragm portion 31 toward the pair of recesses 20C and 20D.

As in the protrusions 40 illustrated in FIG. 1 and FIG. 2, the protrusions 40 illustrated in FIG. 5 include a pair of opposing portions 41 and 42. Each of the pair of opposing portions 41 and 42 extends in the longitudinal direction 103. The pair of opposing portions 41 and 42 face each other across a gap in the lateral direction 102. The pair of opposing portions 41 and 42 are located to overlap edge portions of the pair of recesses 20C and 20D closer to the through-hole 20B when viewed in plan. More specifically, the positions of the pair of opposing portions 41 and 42 illustrated in FIG. 5 in the lateral direction 102 are the same as the positions of the pair of opposing portions 41 and 42 illustrated in FIG. 1 and FIG. 2 in the lateral direction 102.

The protrusions 40 may be disposed on both the base-side electroconductive layer 22 and the diaphragm portion 31. More specifically, the protrusions 40 may be disposed on at least one of the base-side electroconductive layer 22 or the diaphragm portion 31.

The pair of opposing portions 41 and 42 do not have to extend rectilinearly. For example, the pair of opposing portions 41 and 42 may be curved, or may undulate.

The pair of opposing portions 41 and 42 do not have to be parallel to each other.

The pair of opposing portions 41 and 42 may have a shape extending in a direction other than the longitudinal direction 103, for example, a shape extending in the lateral direction 102.

The pair of opposing portions 41 and 42 do not have to have a shape extending linearly in a single direction (longitudinal direction 103 in the first embodiment).

The protrusions 40 do not have to be simply formed from the pair of opposing portions 41 and 42. For example, the protrusions 40 may include, in addition to the pair of opposing portions 41 and 42, a portion that connects first end portions 41A and 42A of the pair of opposing portions 41 and 42 to each other. In this case, the protrusions 40 have a substantially U shape when viewed in plan. For example, the protrusions 40 may include, in addition to the pair of opposing portions 41 and 42, a portion that connects the first end portions 41A and 42A of the pair of opposing portions 41 and 42 to each other, and a portion that connects second end portions 41B and 42B to each other. In this case, the protrusions 40 have a rectangular loop shape when viewed in plan.

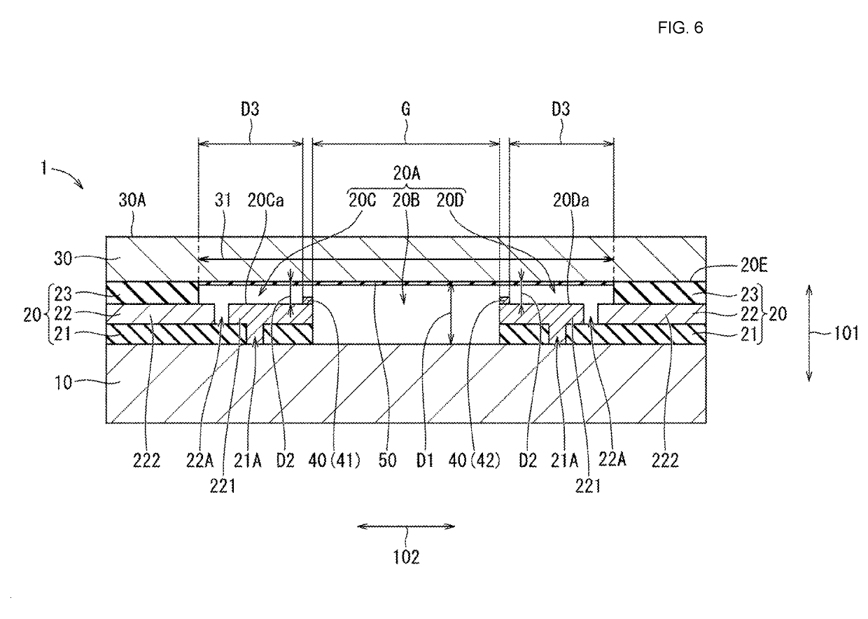

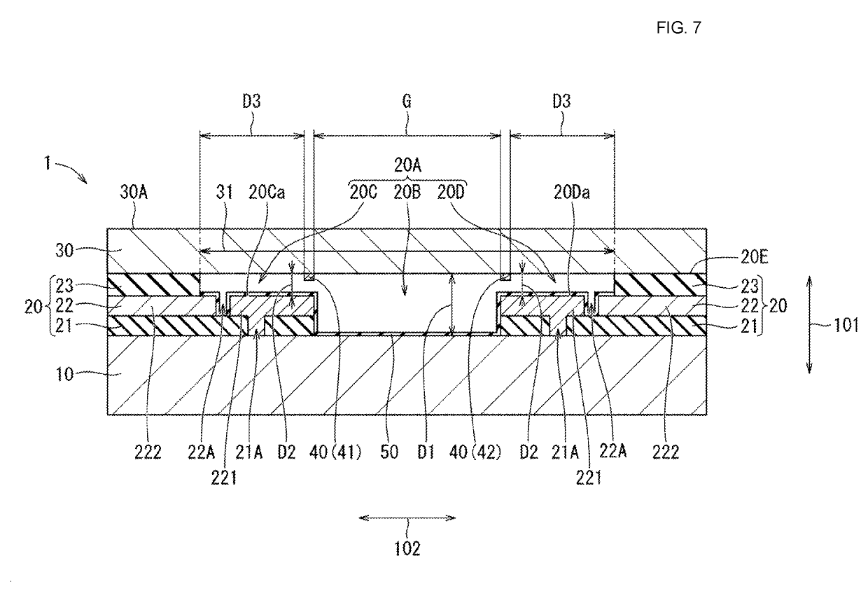

FIG. 6 is a schematic end view of a pressure sensor device according to a modification example of the first embodiment of the present disclosure, at a portion corresponding to FIG. 1. FIG. 7 is a schematic end view of a pressure sensor device according to a modification example of the first embodiment of the present disclosure, at a portion corresponding to FIG. 1.

As illustrated in FIG. 6 and FIG. 7, the protrusions 40 may be formed from an electroconductive material. For example, the protrusions 40 may be formed from polysilicon, which is the same material as the base-side electroconductive layer 22. In this case, the protrusions 40 may be formed integrally with the base-side electroconductive layer 22.

When the protrusions 40 have electroconductivity, the diaphragm portion 31 that warps with an application of pressure may be electrically connected to the base-side electroconductive layer 22 with the protrusions 40 interposed therebetween. Thus, to prevent electrical connection between the diaphragm portion 31 and the base-side electroconductive layer 22, the pressure sensor device 1 including the protrusions 40 having electroconductivity further includes an insulator film 50 having insulating properties.

In the structure illustrated in FIG. 6, as in the structure illustrated in FIG. 1, the protrusions 40 are disposed on the base-side electroconductive layer 22 (on the surface of the base-side electroconductive layer 22 facing the pair of recesses 20C and 20D). In this case, the insulator film 50 is disposed on the surface of the diaphragm portion 31 facing the opening 20A.

In the structure illustrated in FIG. 7, as in the structure illustrated in FIG. 5, the protrusions 40 are disposed on the diaphragm portion 31 (on the surface of the diaphragm portion 31 facing the pair of recesses 20C and 20D). In this case, the insulator film 50 is disposed on the surfaces of the base-side electroconductive layer 22 and the base 10 facing the opening 20A.

The insulator film 50 may be located at any position at which at least electric connection between the diaphragm portion 31 and the base-side electroconductive layer 22 can be prevented. For example, in the structure illustrated in FIG. 6, the insulator film 50 is disposed over the entire surface of the diaphragm portion 31 facing the opening 20A. However, the insulator film 50 may be simply disposed at portions of the surface facing the protrusions 40 in the lamination direction 101. For example, in the structure illustrated in FIG. 7, the insulator film 50 is disposed over the surfaces of the base-side electroconductive layer 22 and the base 10 facing the opening 20A. However, the insulator film 50 may be simply disposed on the base-side electroconductive layer 22, and does not have to be disposed on the base 10.

The insulator film 50 may be disposed to cover the protrusions 40.

As described above, the insulator film 50 covers either one or both of the protrusions 40 and portions of the diaphragm portion 31 that comes into contact with the protrusions 40 when the diaphragm portion 31 warps. In the structure including the insulator film 50, the insulator film 50 is located between the diaphragm portion 31 and the protrusions 40 or between the base-side electroconductive layer 22 and the protrusions 40. This structure prevents electric connection of the diaphragm portion 31 that warps with an application of pressure and the base-side electroconductive layer 22 with the protrusions 40 interposed therebetween.

In the structures illustrated in FIG. 6 and FIG. 7, the protrusions 40 are formed from an electroconductive material, and the protrusions 40 can thus be formed integrally with another electroconductive material, for example, the base-side electroconductive layer 22. The pressure sensor device 1 with any of these structures can be manufactured with fewer processes.

In contrast, when the protrusions 40 are formed from an electroconductive material, the diaphragm portion 31 and the base 10 or the base-side electroconductive layer 22 may be electrically connected with the protrusions 40 interposed therebetween when the diaphragm portion 31 warps. In the structures illustrated in FIG. 6 and FIG. 7, the insulator film 50 can prevent the electric connection described above.

### Second Embodiment

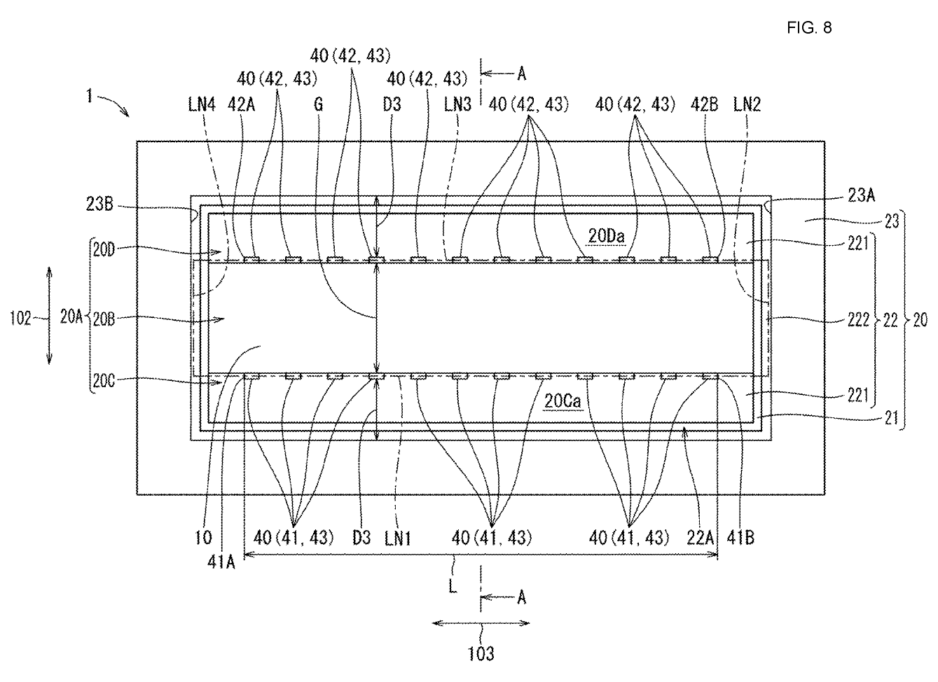

FIG. 8 is a schematic plan view of a pressure sensor device according to a second embodiment of the present disclosure, at a portion excluding an electrode. A pressure sensor device 1A according to a second embodiment differs from the pressure sensor device 1 according to the first embodiment in that the pair of opposing portions 41 and 42 included in the protrusions 40 include multiple protrusions 43. Hereafter, the difference from the first embodiment is described. The points the same as those of the pressure sensor device 1 according to the first embodiment are denoted with the same reference signs and not generally being described, but may be described as needed.

As illustrated in FIG. 8, the pair of opposing portions 41 and 42 include multiple protrusions 43. The multiple protrusions 43 protrude in the lamination direction 101 from the fixed electrodes 221 of the base-side electroconductive layer 22 toward the pair of recesses 20C and 20D. The multiple protrusions 43 are arranged while being spaced one from another in the longitudinal direction 103. Thus, the multiple protrusions 43 together form a linear shape extending in the longitudinal direction 103.

In FIG. 8, both the pair of opposing portions 41 and 42 include the multiple protrusions 43, but either one of the pair of opposing portions 41 and 42 may include multiple protrusions 43. In FIG. 8, each of the pair of opposing portions 41 and 42 is entirely formed from the multiple protrusions 43, but may be formed from the multiple protrusions 43 at a part, and formed in a linear shape at the portion excluding the above part.

In the second embodiment, the pair of opposing portions 41 and 42 include the multiple protrusions 43 arranged while being spaced apart one from another. The multiple protrusions 43 come into contact with the diaphragm portion 31 that has warped. Thus, compared to a structure where each of the pair of opposing portions 41 and 42 extends linearly, the diaphragm portion 31 that is in contact with the multiple protrusions 43 is more likely to warp. This structure can improve the accuracy with which a change of capacitance caused by warpage of the diaphragm portion 31 can be detected.

### Third Embodiment

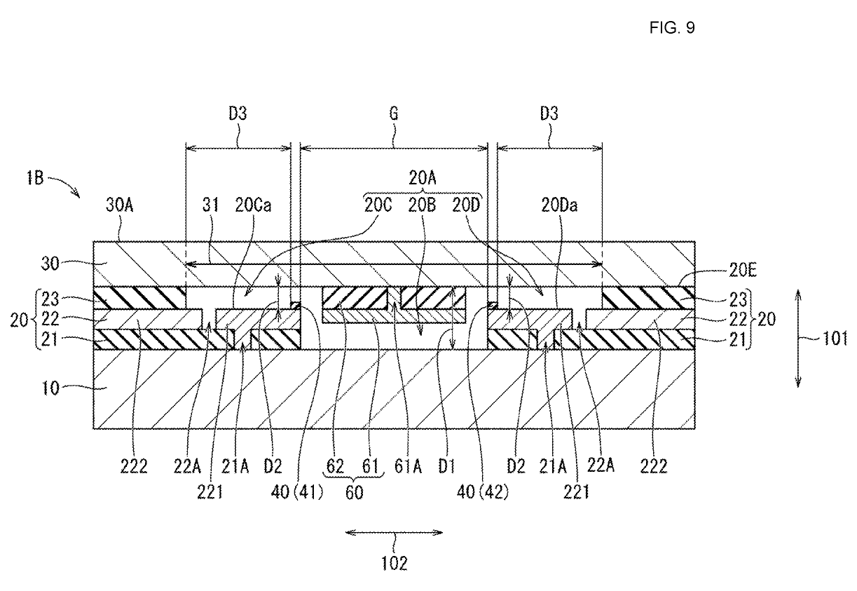

FIG. 9 is a schematic end view of a pressure sensor device according to a third embodiment of the present disclosure, at a portion corresponding to FIG. 1. A pressure sensor device 1B according to a third embodiment differs from the pressure sensor device 1 according to the first embodiment in that it further includes an inner layer 60. Hereafter, the difference from the first embodiment is described. The points the same as those of the pressure sensor device 1 according to the first embodiment are denoted with the same reference signs and not generally being described, but may be described as needed.

As illustrated in FIG. 9, the pressure sensor device 1B further includes the inner layer 60. The inner layer 60 is laminated on the surface of the diaphragm portion 31 facing the opening 20A (lower surface of the diaphragm portion 31). The inner layer 60 is laminated on the diaphragm portion 31 at a portion between the pair of opposing portions 41 and 42 in the lateral direction 102. The inner layer 60 is laminated on the surface of the diaphragm portion 31 facing the opening 20A, at a portion facing the through-hole 20B.

The inner layer 60 includes an electrode-side conductive layer 61 having electroconductivity, and an electrode-side insulating layer 62 having insulating properties. The electrode-side insulating layer 62 is laminated on the diaphragm portion 31. The electrode-side conductive layer 61 is laminated on a surface of the electrode-side insulating layer 62 opposite to a surface facing the diaphragm portion 31. More specifically, the electrode-side insulating layer 62 is located between the electrode-side conductive layer 61 and the diaphragm portion 31. The electrode-side conductive layer 61 is electrically connected to the electrode 30 through a through-hole 61A extending through the electrode-side insulating layer 62 in the lamination direction 101.

In the third embodiment, the electrode-side conductive layer 61 is formed from polysilicon, and the electrode-side insulating layer 62 is formed from silicon dioxide. The material of electrode-side conductive layer 61 is not limited to polysilicon, and the material of the electrode-side insulating layer 62 is not limited to silicon dioxide.

The electrode-side insulating layer 62 is located at the same position as the second base-side insulating layer 23 of the intermediate layer 20 in the lamination direction 101. Thus, in the procedure of manufacturing the pressure sensor device 1B, the electrode-side insulating layer 62 and the second base-side insulating layer 23 can be laminated in the same process. In the third embodiment, the electrode-side insulating layer 62 has the same thickness as the second base-side insulating layer 23, but may have a different thickness from the second base-side insulating layer 23.

The electrode-side conductive layer 61 is located at the same position as the base-side electroconductive layer 22 of the intermediate layer 20 in the lamination direction 101. Thus, in the procedure of manufacturing the pressure sensor device 1B, the electrode-side conductive layer 61 and the base-side electroconductive layer 22 can be laminated in the same process. In the third embodiment, the electrode-side conductive layer 61 has a different thickness from the base-side electroconductive layer 22, but may have the same thickness as the base-side electroconductive layer 22.

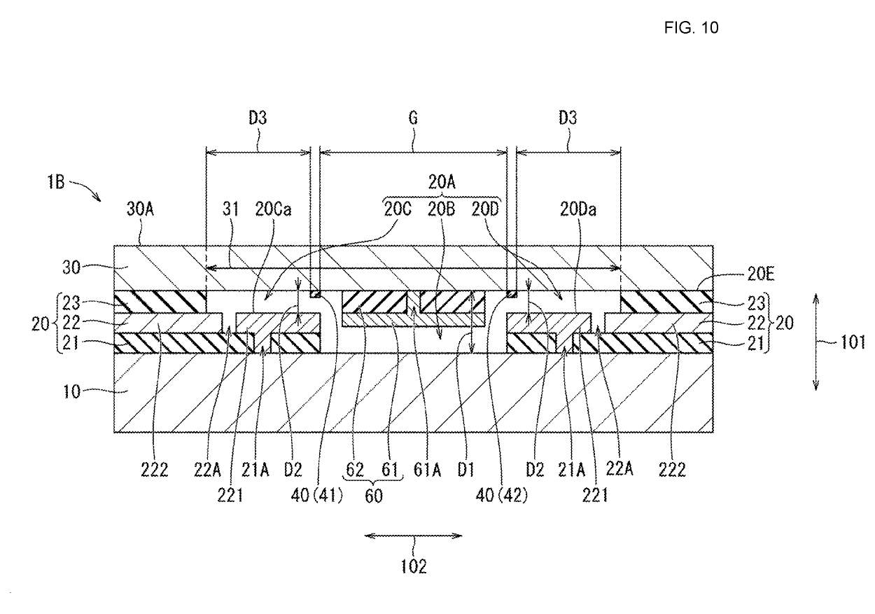

FIG. 10 is a schematic end view of a pressure sensor device according to a modification example of the third embodiment of the present disclosure, at a portion corresponding to FIG. 1. As illustrated in FIG. 10, as in the modification example of the first embodiment illustrated in FIG. 5, the third embodiment may also include protrusions 40 disposed on the diaphragm portion 31.

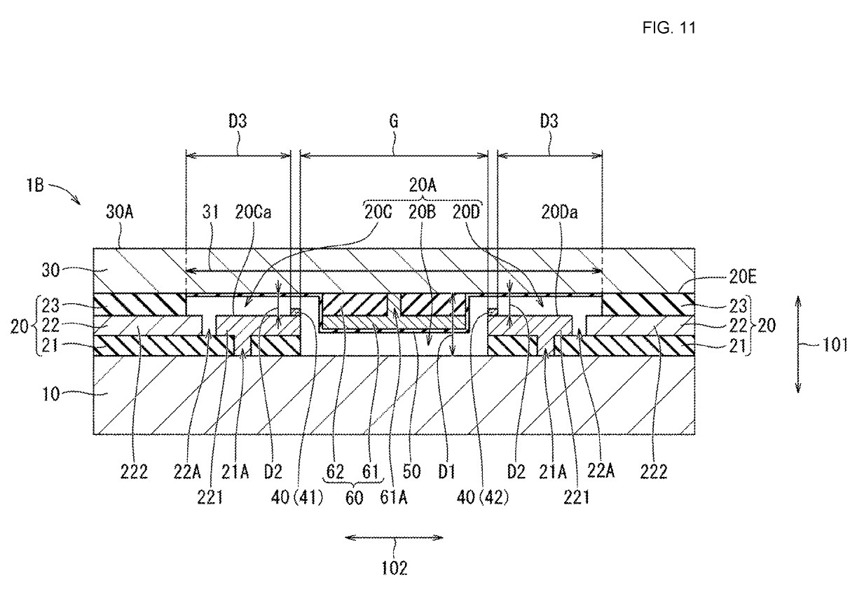

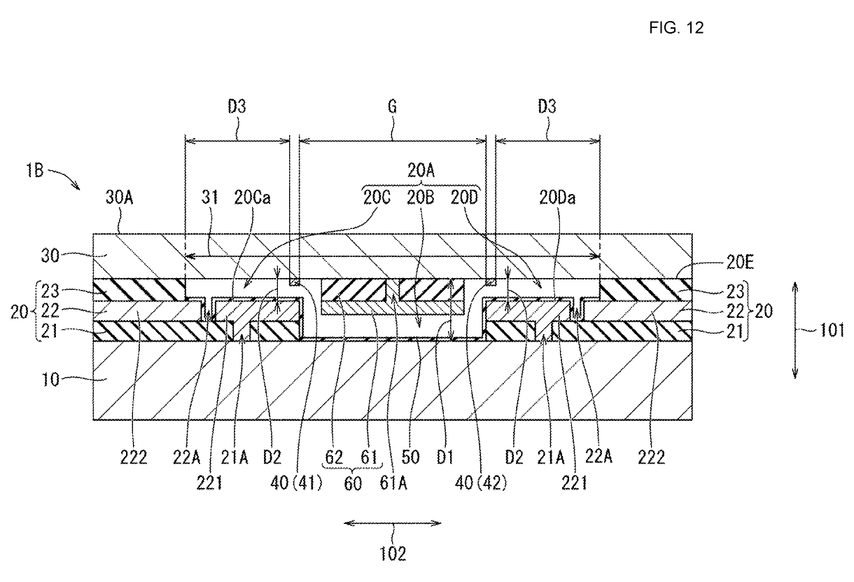

FIG. 11 is a schematic end view of a pressure sensor device according to a modification example of the third embodiment of the present disclosure, at a portion corresponding to FIG. 1. FIG. 12 is a schematic end view of a pressure sensor device according to a modification example of the third embodiment of the present disclosure, at a portion corresponding to FIG. 1. As illustrated in FIG. 11 and FIG. 12, as in the modification examples of the first embodiment illustrated in FIG. 6 and FIG. 7, the third embodiment may also include an insulator film 50.

For example, in the structure illustrated in FIG. 11, the insulator film 50 is disposed on the surfaces of the diaphragm portion 31 and the inner layer 60 facing the opening 20A. For example, in the structure illustrated in FIG. 12, the insulator film 50 is disposed on the surfaces of the base-side electroconductive layer 22 and the base 10 facing the opening 20A.

In the third embodiment, the gap between the electrode 30 and the base 10 or the base-side electroconductive layer 22 can be adjusted by changing the thickness of the inner layer 60 in addition to by changing the thickness of the intermediate layer 20 (dimension in the lamination direction 101). Thus, the gap can be adjusted more freely.

Forming a layer with an excessively large thickness is more difficult than forming a layer with an appropriate thickness. In the third embodiment, the inner layer 60 includes the electrode-side conductive layer 61 and the electrode-side insulating layer 62. More specifically, the inner layer 60 includes two layers. Thus, the entire inner layer 60 can obtain a large thickness without excessively increasing the thickness of each of the electrode-side conductive layer 61 and the electrode-side insulating layer 62. The third embodiment can thus more easily increase the thickness of the inner layer 60 than when the inner layer 60 is formed from a single layer.

In the embodiments described above as an example, the opening 20A has the through-hole 20B and the pair of recesses 20C and 20D, but the opening 20A may simply have the through-hole 20B. In this case, the side surfaces of the through-hole 20B are defined by the intermediate layer 20 (the first base-side insulating layer 21, the base-side electroconductive layer 22, and the second base-side insulating layer 23). The protrusions 40 are disposed on the base 10 (more specifically, on the surface of the base 10 facing the opening 20A) instead of on the base-side electroconductive layer 22, and protrude toward the opening 20A.

In the pressure sensor device including the opening 20A simply having the through-hole 20B, the diaphragm portion 31 and the base 10 form a capacitor. The diaphragm portion 31 warps as a single film while not being in contact with the protrusions 40. The diaphragm portion 31 warps as multiple films while being in contact with the protrusions 40.

The opening 20A may simply have a single recess without having the through-hole 20B. In this case, the bottom surface of the single recess corresponds to the bottom surface of the opening 20A. The protrusions 40 are disposed on the bottom surface of the single recess, and protrude toward the opening 20A (the single recess).

The bottom surface of the single recess may be any layer in the intermediate layer 20. For example, when the bottom surface of the single recess is the base-side electroconductive layer 22 with electroconductivity, the diaphragm portion 31 and the base-side electroconductive layer 22 form a capacitor.

In each of the above embodiments described above as an example, the intermediate layer 20 includes the first base-side insulating layer 21, the base-side electroconductive layer 22, and the second base-side insulating layer 23, but the structure of the intermediate layer 20 is not limited to the above structure. For example, the intermediate layer 20 may be formed from a single layer with insulating properties. In this case, for example, the diaphragm portion 31 and the base 10 form a capacitor.

By combining any two or more of the various embodiments, the effect of each of the embodiments can be exerted.

Each of the various embodiments may simply have at least one of features of the pressure sensor device of the present disclosure.

### Examples are described below.

The pressure sensor device 1 according to the first embodiment has a first feature and a second feature. The first feature is that the opening 20A includes the through-hole 20B with the depth D1 and the pair of recesses 20C and 20D with the depth D2 smaller than the depth D1. The second feature is that the area surrounded by the four virtual straight lines LN1, LN2, LN3, and LN4 when viewed in plan is rectangular.

The pressure sensor device does not have to have the second feature while having the first feature. The pressure sensor device described herein may include a pressure sensor device that does not have the second feature while having the first feature.

In contrast, the pressure sensor device does not have to have the first feature while having the second feature. The pressure sensor device described herein may include a pressure sensor device that does not have the first feature while having the second feature.

The pressure sensor device may have both the first feature and the second feature.

Although the present disclosure has been fully described in relation to preferred embodiments with reference to the drawings as appropriate, various modifications and alterations will be apparent to those skilled in the art. Such modifications and alterations are to be understood as being included in the scope of the present disclosure, insofar as they do not depart from the scope defined by the appended claims.

### REFERENCE SIGNS LIST

1 pressure sensor device

10 base

20 intermediate layer

20A opening

20B through-hole

20C recess

20Ca bottom surface

20D recess

20Da bottom surface

20E upper surface (surface of intermediate layer facing electrode)

22 base-side electroconductive layer

30 electrode

31 diaphragm portion

40 protrusion

41 opposing portion

41A first end portion

41B second end portion

42 opposing portion

42A first end portion

42B second end portion

43 protrusion

50 insulator film

60 inner layer

61 electrode-side conductive layer

62 electrode-side insulating layer

101 lamination direction

102 lateral direction (width direction)

103 longitudinal direction (extension direction)

LN1 virtual straight line

LN2 virtual straight line

LN3 virtual straight line

LN4 virtual straight line

1. A pressure sensor device, comprising:
a base having electroconductivity;
an intermediate layer on the base and defining an opening;
an electrode having electroconductivity on a first surface of the intermediate layer opposite to a second surface thereof facing the base, the electroconductive electrode including a diaphragm portion that overlaps the opening when viewed in a lamination direction, the electroconductive electrode being electrically insulated from the base,
wherein the opening includes:
a through-hole that extends through the intermediate layer in the lamination direction, and
a pair of recesses on the first surface of the intermediate layer, the pair of recesses being positioned such that the through-hole is therebetween, and the pair of recesses are continuous with the through-hole, and recessed in the lamination direction,
wherein the intermediate layer includes a base-side electroconductive layer is a bottom surface of the pair of recesses and is electrically connected to the base,
wherein the diaphragm portion faces the base-side electroconductive layer in the lamination direction across the pair of recesses, and faces the base in the lamination direction across the through-hole; and
protrusions on a surface of at least one of the base-side electroconductive layer or the diaphragm portion facing the pair of recesses and protruding toward the pair of recesses,
wherein the protrusions include a pair of opposing portions that oppose each other while spaced in a width direction between the pair of recesses, and
wherein the pair of opposing portions overlap edge portions of the pair of recesses closer to the through-hole when viewed in the lamination direction.

2. The pressure sensor device according to claim 1, wherein the protrusions are on the surface of the base-side electroconductive layer.

3. The pressure sensor device according to claim 1, wherein the protrusions are on the surface of the diaphragm portion.

4. The pressure sensor device according to claim 1,
wherein the pair of opposing portions extend in an extension direction that crosses the width direction, and
wherein an area of the diaphragm portion between the pair of opposing portions in the width direction is rectangular when viewed in the lamination direction.

5. The pressure sensor device according to claim 4, wherein a dimension of each of the pair of opposing portions in the extension direction is longer than a gap between the pair of opposing portions in the width direction.

6. The pressure sensor device according to claim 4, wherein at least one of the pair of opposing portions includes a plurality of protrusions arranged in the extension direction while being spaced one from another.

7. The pressure sensor device according to claim 1, further comprising:
an inner layer on a surface of the diaphragm portion between the pair of opposing portions in the width direction, the surface facing the opening,
wherein the inner layer includes an electrode-side conductive layer having electroconductivity and electrically connected to the electrode.

8. The pressure sensor device according to claim 7, wherein the inner layer further includes an electrode-side insulating layer between the electrode-side conductive layer and the diaphragm portion and having insulating properties.

9. The pressure sensor device according to claim 1, wherein a gap between the pair of opposing portions in the width direction is longer than a shortest distance between each of the pair of opposing portions and an outer edge of the opening in the width direction.

10. The pressure sensor device according to claim 1,
wherein the protrusions comprise a material having electroconductivity, and
wherein the pressure sensor device further comprises an insulator film that has insulating properties and that covers either the protrusions or portions of the diaphragm portion that come into contact with the protrusions when the diaphragm portion warps, or both the protrusions and the portions of the diaphragm portion.

11. A pressure sensor device, comprising:
a base having electroconductivity;
an intermediate layer on the base and defining an opening;
an electrode having electroconductivity on a first surface of the intermediate layer opposite to a second surface thereof facing the base, the electroconductive electrode including a diaphragm portion that overlaps the opening when viewed in a lamination direction, the electroconductive electrode being electrically insulated from the base; and
protrusions on a surface of at least one of the base or the diaphragm portion facing the opening and protruding toward the opening,
wherein the protrusions each extend in an extension direction on the surface facing the opening, and include a pair of opposing portions that oppose each other while being spaced in a width direction that crosses the extension direction, and
wherein an area of the diaphragm portion between the pair of opposing portions in the width direction is rectangular when viewed in the lamination direction.

12. The pressure sensor device according to claim 11, wherein the protrusions are on the surface of the base-side electroconductive layer.

13. The pressure sensor device according to claim 11, wherein the protrusions are on the surface of the diaphragm portion.

14. The pressure sensor device according to claim 11, wherein a dimension of each of the pair of opposing portions in the extension direction is longer than a gap between the pair of opposing portions in the width direction.

15. The pressure sensor device according to claim 11, wherein at least one of the pair of opposing portions includes a plurality of protrusions arranged in the extension direction while being spaced one from another.

16. The pressure sensor device according to claim 11, further comprising:
an inner layer on a surface of the diaphragm portion between the pair of opposing portions in the width direction, the surface facing the opening,
wherein the inner layer includes an electrode-side conductive layer having electroconductivity and electrically connected to the electrode.

17. The pressure sensor device according to claim 16, wherein the inner layer further includes an electrode-side insulating layer between the electrode-side conductive layer and the diaphragm portion and having insulating properties.

18. The pressure sensor device according to claim 11, wherein a gap between the pair of opposing portions in the width direction is longer than a shortest distance between each of the pair of opposing portions and an outer edge of the opening in the width direction.

19. The pressure sensor device according to claim 11,
wherein the protrusions comprise a material having electroconductivity, and
wherein the pressure sensor device further comprises an insulator film that has insulating properties and that covers either the protrusions or portions of the diaphragm portion that come into contact with the protrusions when the diaphragm portion warps, or both the protrusions and the portions of the diaphragm portion.
